(19) United States
(12) Patent Application Publication
(10) Pub. No.: US 2003/0120977 A1
(43) Pub. Date: Jun. 26, 2003

(54) Debugging method through serial port under system shutdown and standby conditions

(76) Inventor: Chih-Chien Tang, Taipei (TW)

Correspondence Address: BIRCH STEWART KOLASCH & BIRCH, PO BOX 747, FALLS CHURCH, VA, 22040-0747, US

(21) Appl. No.: 10/022,910

(22) Filed: Dec. 20, 2001

(51) Int. Cl. G06F 11/26

(52) U.S. Cl. 714/38

(57) ABSTRACT

The invention is a debugging method through a computer serial port under system shutdown and standby conditions. The object of the invention is to implant a power-off debug program and a standby debug program into Basic Input Output system of a computer. Power management is used to supply power to the BIOS and serial port when the system is booting up. A switch is provided to turn on/off the serial port output condition of the destination system. A cable is used to connect a remote system and the destination system. Monitoring software is executed in the remote system and the remote system is used to monitor the BIOS debug conditions of the destination system. The invention allows a local system to debug under system boot-up or system standby conditions. The efficiency of the system debug process is thus increased.

### BACKGROUND OF THE INVENTION

1. Field of the Invention

The invention relates to a serial port debug under system shutdown and standby conditions. It can be applied to the BIOS debug of a computer system.

2. Related Art

As soon as a computer is booting up, the computer system will search and then execute Basic Input Output System (BOIS). A boot-up procedure is subsequently processed after the BIOS bas been executed. BIOS is a kind of firmware; hardware and software are able to communicate with each other with the help of the basic program code inside the BIOS. The functions of BIOS are initialization of peripheral devices, implementation, and parameterization. Subsequently, BIOS will do a Power-on Self-Test (POST) on the computer system. After peripheral devices are initialized, BIOS searches the location of the operation system, and then passes system control to the operation system in order to process general boot-up sequences.

Obviously, BIOS is the first process in the computer operation. A computer will not work normally if BIOS is not designed properly. Therefore, computer engineers have to make sure the BIOS is going to work properly when it is being programmed. One general way to ensure the normal operation of BIOS is to add a debug program to a specific location of BIOS. As for the BIOS operations mentioned above, a section of the debug program is added at the end of each operation. Hence, it is easy for the engineer to find bugs during the operation of the BIOS program.

Nowadays, many BIOS program are stored in the flash memory, allowing the BIOS to be upgraded. However, if something goes wrong with the updating program, the computer system is cannot boot up. This indicates that the debug process of the BIOS is a very important task.

However, the BIOS program begins operation as soon as the system is turned on. The display device of the computer is able to display data after it is initialized by the BIOS. In this case, the engineer is unable to know how much the BIOS program has operated and whether or not anything is wrong with the BIOS program.

Therefore, BIOS programmers have to use proper tools for monitoring BIOS operation to detect if the BIOS program is working normally. The detection can be done if we check whether or not the aforementioned BIOS debug program is working properly. One of the tools is a serial port debug that allows the operation result of the BIOS debug program to be shown on the display device connected to a serial port. Therefore, engineers are able to know the operation conditions of BIOS. In other words, engineers are able to know if BIOS is working properly by observing the result of the debug program shown on the display unit connected to the serial port.

Within general conditions of OEM (you should define OEM) computer manufacturers, the operation system has not been loaded onto the computer system before the computer leaves the factory. The test of the computer is done by the BIOS. If the BIOS is not working properly, the production of the computer will be seriously affected. Therefore, ensuring the proper operation of the BIOS is an important consideration for the OEM computer industry. Therefore, the BIOS should be tested before the computer is manufactured.

However, the conventional technique mentioned above is to debug when the computer system is turned on. It is not able to debug when the computer is shut down (power off condition). In this case, the system debugging process is not very efficient. Furthermore, the information that can be obtained during the debugging process is only numeric data, not text data. This necessitates the extra work of looking up the definition of numeric debug codes. Therefore, debugging the BIOS under the system shutdown and system standby conditions is an important issue for engineers to consider.

### SUMMARY OF THE INVENTION

In order to avoid the drawbacks of the conventional technology, the invention provides a debug method through a serial port under system shutdown and standby conditions. It enables engineers to debug under system shutdown and standby conditions. Furthermore, text data or numeric data can be obtained to display the results of the debug.

The debugging method through a serial port under system shutdown and standby conditions of the invention uses a remote system to debug the BIOS of a destination system. It comprises the following steps: the BIOS of a destination computer is compiled in the power-off debug program and the standby debug program; the power management of the destination system is set to system shutdown to provide power to the BIOS and serial port of the computer; a cable is used to connect a remote serial port of the remote system to a destination serial port of the destination system; monitoring software is initiated in the remote system and used to read the output from the destination serial port of the destination system; and monitoring software is used to check if the output from the destination serial port under system shutdown or standby conditions is normal.

Furthermore, the invention provides a switch for the output mode of the local serial port. The debug results will be displayed through the serial port and regular operation of the serial port is processed when the switch is turned on.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 illustrates the system structure of the debugging method through a serial port under system shutdown and standby conditions of the invention, and

FIG. 2 illustrates a flow chart of the debugging method through a serial port under system shutdown and standby conditions of the invention.

### DETAILED DESCRIPTION OF THE INVENTION

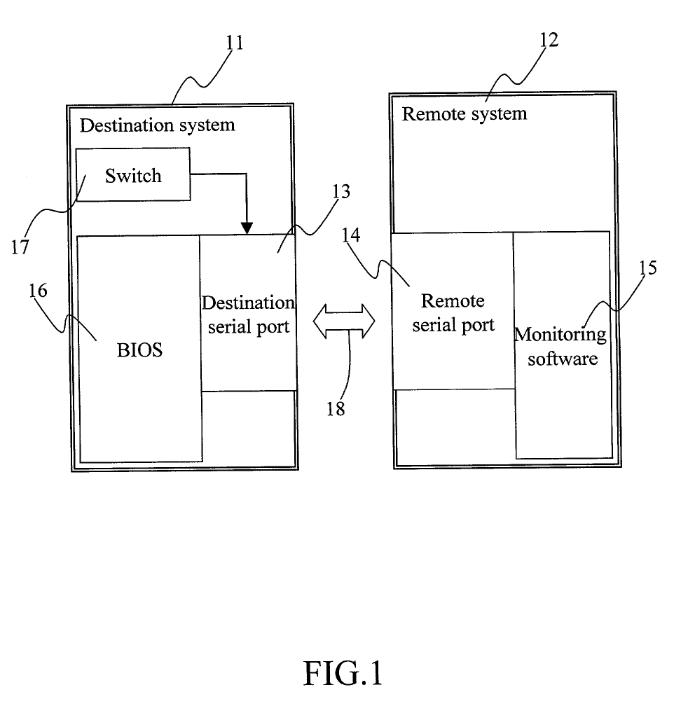

FIG. 1 illustrates the system structure of the debugging method through a serial port under system shutdown and standby conditions of the invention. The destination system 11 of the invention comprises a BIOS 16 destination serial port 13 and switch 17. The remote system 12 comprises a remote serial port 14 and monitoring software 14. A cable 18 is used to connect monitoring software 14 and the destination serial port 13.

In the destination system, the BIOS 16 comprises a compiled power-off debug program and standby debug program. In other words, the two debug programs are added to to the program code of the BIOS 16 when the BIOS 16 is being burned into the system. The power-off debug program debugs the BIOS 16 after the system is shutdown. The standby debug program debugs the BIOS 16 when the system is on standby.

Furthermore, the debug programs provided by the invention output either text data or numerical data, or a combination of text and numerical data. Text data allows the results of debugging to be shown as text, meaning that debug results and debug conditions can be easily understood.

When the system is shut down, the power is cut off. To overcome the problem of power deficiency, the invention supplies power to the BIOS 16 and the destination serial port 13 by way of power management. Therefore, the BIOS 16 and the destination serial port are still able to work after the system is shut down. and the power-off debug program is able to debug after the system is shut down.

As shown in FIG. 1, the invention provides a switch 17 to control the output status of the destination serial port 13. The destination serial port 13 can output text or numerical data generated by the debug program when the switch 17 is turned on. Conversely, the destination serial port 13 outputs regular results when the switch 17 is turned off. This design allows users to choose the type of result output from the destination serial port 13. If a system user wants to know the debugging status, s/he can turn on the switch 17. Conversely, he can turn off the switch 17 if he doesn't need to see the debugging status.

According to the technique disclosed in the invention, debugging can be done through the serial port after the system is shut down. In FIG. 1, the destination system 12 provides monitoring software 15, such as Hyper Terminal software, to monitor data output from the destination serial port 13 and the remote serial port 14. Users are able to monitor output status of the destination serial port 13 after the monitoring software 15 is initiated.

When users wish to confirm the debugging process of the BIOS 16, they can turn on the switch 17. At this point, when users shut down the destination system 11, the power-off debug program of the BIOS 16 starts to debug, and the results, which are defined as either text or numerical data by the debug program code, are transferred from the remote serial port 14 to the remote system 12 by way of the destination serial port 13 and the cable 18. Similarly, when the system is on standby, the standby debug program of the BIOS 16 starts to debug, and the results, which are defined as either text or numerical data by the debug program code, are transferred from the remote serial port 14 to the remote system 12 by way of the destination serial port 13 and the cable 18. Hence, users can use the remote system 12 to monitor the debug status of the BIOS 16 in the destination system 11 by using the monitoring software 15.

If users turn off the switch 17, they are not able to monitor the debug status of the destination system 11. Nevertheless, the destination system 11 is still being debugged when the system is shut down or on standby.

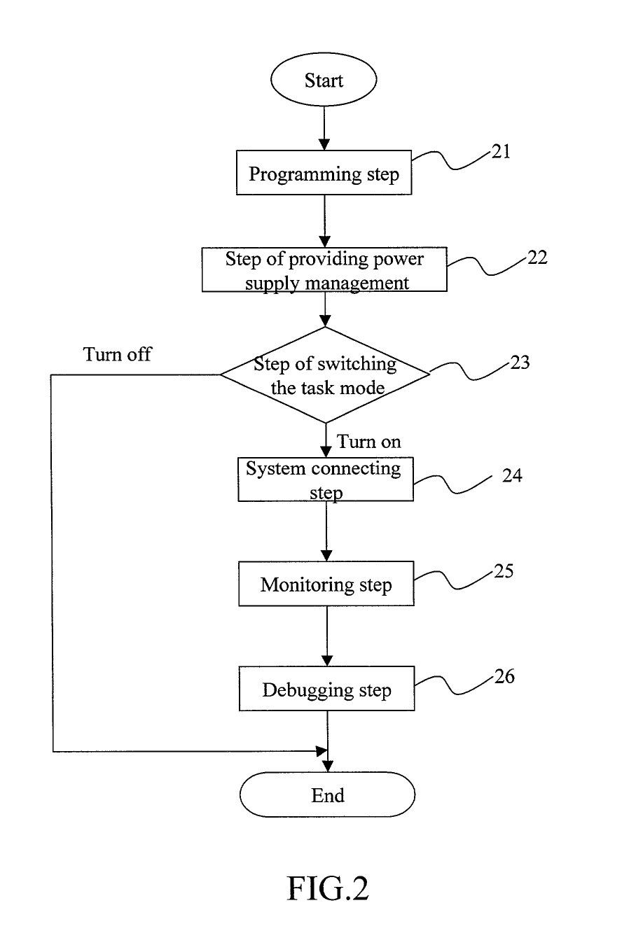

In order to further understand the technique disclosed by the invention, please refer to FIG. 2. This is a flow chart of the debugging method through a serial port under system shutdown and standby conditions of the invention. Also refer to FIG. 1, which illustrates the system structure of the debugging method through a serial port under system shutdown and standby conditions of the invention.

The debugging method through a serial port under system shutdown and standby conditions of the invention comprises the following steps: the programming step (step 21), the step of providing power supply management (step 22), the step of switching the task mode (step 23), the system connecting step (step 24), the monitoring step (step 25), and the debugging step (step 26).

Firstly, in the programming step (step 21), a standby debug program and a power-off debug program are burned into the BIOS 16. The power-off debug program will debug the BIOS 16 of the system after the system is shut down. The standby debug program debugs the BIOS 16 when the system is on standby.

Then, in the step of providing power supply management step (step 22), utilize the power supply management function of the computer, supply power to the BIOS 16 and the destination serial port 13 when the system is in the power-off condition. Hence, the BIOS 16 and the destination serial port 13 are still able to work after the system is shut down. In other words, the power-off debug program debugs the BIOS 16 when the system is shut down.

Next is the step of switching the task mode (step 23). The invention provides a switch 17 to control the output status of the destination serial port 13. The destination serial port 13 can output text or numerical data generated by the debug program when the switch 17 is turned on. Conversely, the destination serial port 13 outputs regular results when the switch 17 is turned off.

When users turn on the switch 17, the BIOS debug program code will come out from the destination serial port 13. The debug program code can be text or numerical data. Next is the the system connecting step. A cable 18 is used to connect the destination serial port 13 and the remote serial port 14.

The monitoring step (step 25) is then begun, wherein monitoring software 15, such as Hyper Terminal software, is utilized in the remote system 12 to monitor either text data or numerical data output from the BIOS 16 debug program. Users can monitor data transferred from the destination serial port 13 by way of the remote serial port 14, and monitor the output status of the destination serial port 13.

Finally, the debugging step (step 26) is performed, wherein monitoring software will show the debug results of the BIOS 16. When users shut down the destination system 11, the power-off debug program of the BIOS 16 starts to debug, and the results, which are defined as either text or numerical data by the debug program code, are transferred from the remote serial port 14 to the remote system 12 by way of the destination serial port 13 and the cable 18. Similarly, when the system is on standby, the standby debug program of the BIOS 16 starts to debug, and the results, which are defined as either text or numerical data by the debug program code, are transferred from the remote serial port 14 to the remote system 12 by way of the destination serial port 13 and the cable 18. Hence, users can use the remote system 12 to monitor the debug status of the BIOS 16 in the destination system 11 by using the monitoring program 15.

By using the debugging method through a serial port under system shutdown and standby conditions of the invention, users are able to use remote system to monitor the debugging process of the BIOS in the destination system. The most important function of the invention is that it allows the BIOS of the destination system to undergo a debugging process no matter whether the system power is on or off.

By using the technique disclosed by the invention, it is possible for a local system to be debugged when the system is under power-off or standby conditions. The debugging process can be performed no matter whether the system power is on or off. This increases the efficiency of the debugging process.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A debugging method through serial port under system shutdown condition and standby condition, the debugging method is used in a remote system to debug a destination system, comprises following steps:
a programming step: a power-off debug program and a standby debug program are compiled and burn into a BIOS,
a power supply management providing step: a power supply management of said destination system is set to be performed when the system is shutdown and supply power to the BIOS and said destination system,
a system connecting step: a cable is used to connect a remote serial port of the remote system and the destination serial port of said destination system,
a monitoring step: a monitoring software is executed in the remote system, the result from the destination serial port of said destination system is read by said monitoring software, and
a debugging step: the monitoring software is used to check if the output from the destination serial port of said destination system is normal.

2. A debugging method through serial port under system shutdown condition and standby condition of claim 1, wherein said power-off debug program generates either text data or numerical data.

3. A debugging method through serial port under system shutdown condition and standby condition of claim 1, wherein the power-off debug program is able to generate four digits numerical data.

4. A debugging method through serial port under system shutdown condition and standby condition of claim 1, wherein the standby debug program generates either text data or numerical data.

5. A debugging method through serial port under system shutdown condition and standby condition of claim 1, wherein the standby debug program is able to generate four digits numerical data.

6. A debugging method through serial port under system shutdown condition and standby condition of claim 1, further comprises:
a switching task mode step: provide a switch to change the output status of the destination serial port.

7. A debugging method through serial port under system shutdown condition and standby condition of claim 6, wherein said switching task mode step will enable the destination serial port to output the debug result of the BIOS when the switch is turned on.

8. A debugging method through serial port under system shutdown condition and standby condition of claim 6, wherein said switching task mode step will enable the destination serial port to output regular result of the BIOS when the switch is turned off.

9. A debugging method through serial port under system shutdown condition and standby condition of claim 1, wherein said monitoring software of the monitoring step is a Hyper Terminal software.

10. A debugging method through serial port under system shutdown condition and standby condition of claim 5, wherein said power-off debug program starts to debug and the debug result is shown on the remote system when the destination system is shutdown.

11. A debugging method through serial port under system shutdown condition and standby condition of claim 5, wherein said standby debug program starts to debug and the debug result is shown on the remote system when the destination system is under standby condition.
